(19) United States
(12) Patent Application Publication
(10) Pub. No.: US 2010/0074112 A1
(43) Pub. Date: Mar. 25, 2010

(54) NETWORK TRAFFIC MONITORING DEVICES AND MONITORING SYSTEMS, AND ASSOCIATED METHODS

(75) Inventors: Kurt Derr, Idaho Falls, ID (US); Milos Manic, Idaho Falls, ID (US)

Correspondence Address: BATTELLE ENERGY ALLIANCE, LLC, P.O. BOX 1625, IDAHO FALLS, ID, 83415-3899, US

(73) Assignee: BATTELLE ENERGY ALLIANCE, LLC, Idaho Falls, ID (US)

(21) Appl. No.: 12/238,123

(22) Filed: Sep. 25, 2008

(51) Int. Cl. H04L 1/00

(52) U.S. Cl. 370/232

(57) ABSTRACT

Network traffic monitoring devices and monitoring systems include a communication module for capturing wireless communications of a wireless device. Processing circuitry is coupled with the communications module and configured to form a new cluster or refine an existing cluster from the captured wireless communications, in which the cluster includes wireless communications having one or more relevant parameters. The processing circuitry is also configured to generate/refine at least one rule set relating to the clusters, create an updated rule set by combining the one or more rule sets to current rule sets, and to compare the captured wireless communications to the updated rule set to determine whether the wireless communications pose a potential threat. Methods of monitoring network traffic are also provided.

### GOVERNMENT RIGHTS STATEMENT

The United States Government has certain rights in this invention pursuant to Contract No. DE-AC07-05ID14517 between the United States Department of Energy and Battelle Energy Alliance, LLC.

### TECHNICAL FIELD

Various embodiments of the present invention relate generally to methods and devices for network traffic analysis. More particularly, embodiments of the present invention relate to computational intelligence methods, systems and devices for monitoring and analyzing wireless network traffic.

### BACKGROUND

Wireless communication systems (such as Bluetooth, WiFi, cellular, ZigBee, etc.) are ubiquitous. Various mobile and other electronic devices (personal digital assistants, smart phones, cell phones, micro PCs, laptops, and other) use wireless technology to communicate and share information. Many wireless communication systems have become widely used and very popular in recent years. For example, Bluetooth technology is widely used for its ability to eliminate cables and form personal networks for exchanging information. Bluetooth is commonly used for data/voice access points, headset communications with mobile phones, and communications with printers, digital cameras, digital video recorders, mobile devices, etc. ZigBee is commonly used for wireless communications in industrial and building automation, consumer electronic devices, interactive toys and games, personal computer peripherals, home security, lighting control, and air conditioning systems. Another popular wireless communication system is WiFi, which is generally used for providing wireless networking connectivity to one or more computers in a specific area. The growth of hotspots and free and fee-based public access points has added to Wi-Fi's popularity. Each of these technologies has found its own niche with a minimal amount of overlap.

Because these wireless technologies use radio waves, there is the potential that a third party could attempt to access or intrude into devices and networks illegally. While security engineers have attempted to slow or halt many types of wireless intrusions, the number of vulnerabilities and risks continues to rise, especially since many wireless devices have conventionally incorporated few security features. Wireless systems are being deployed in many critical infrastructures increasing the number of vulnerabilities to these sectors of an economy. As wireless devices, such as smart phones, increase in use and distribution, and financial and other sensitive transactions become commonplace via such devices, criminal, and other undesirable elements will seek and find more ways to intrude upon wireless systems.

In a wired network, physical security is complicated but manageable. One can restrict physical access to routers, switches, and network hardware. Complicated authentication mechanisms and virtual private networks can provide for even more security. Even if an attacker plugs into a wired network, it is not easy to penetrate in light of the conventional security measures which are typically in place. Wireless communications, however, are not nearly as secure. Disassembling network packets and transmitting them wirelessly affords the capability of anyone within reach to see them. An attacker may be able to join or passively monitor a network from more than a mile away with a high-gain antenna without detection. Confidential information can be leaked, even when encryption is used to protect the actual contents of the wireless communications.

The extensive growth of the Internet and increasing availability of tools and tricks for intruding and attacking networks have prompted intrusion detection to become a critical component of network administration. An intrusion can be defined as any set of actions that threaten the integrity, confidentiality, or availability of a network resource (such as user accounts, file systems, system kernels, etc.). Conventional intrusion detection systems are generally limiting and do not provide a complete solution. Such systems typically employ a misuse detection strategy, searching for patterns of user behavior that match known intrusion scenarios, which are stored as signatures. This is similar to the method by which many conventional antivirus systems work. A major drawback of this approach is that misuse detection can only identify cases that match the signatures, and are unable to detect new or previously unknown intrusion techniques.

### BRIEF SUMMARY

Various embodiments of the present invention comprise monitoring devices for monitoring network traffic. In one or more embodiments, the monitoring device may comprise a communication module configured to capture wireless communications of a wireless device within a monitored area. Processing circuitry may be coupled with the communications module and configured to form a new cluster or update and refine an existing cluster from at least a portion of the captured wireless communications according to at least one specific parameter identified in at least some of the captured wireless communications. The processing circuitry may generate at least one rule set relating to the formed at least one cluster and may combine the at least one rule set to a current rule set representing previous wireless communications to create an updated rule set. The processing circuitry may further compare the captured wireless communications to the updated rule set to determine a difference from the previous wireless communications, and generate an alert if the difference is greater than a predetermined threshold.

Other embodiments comprise systems for monitoring network traffic. One or more embodiments of such systems may comprise at least one analysis sensor device, at least one storage media, and a visualization and control system. The at least one analysis sensor device may comprise a communication module configured to capture wireless communications of a wireless device within a monitored area and programming configured to form a new cluster or update and refine an existing cluster from the captured wireless communications. The new or existing cluster may comprise wireless communications having at least one relevant parameter. The programming may be further configured to combine the at least one rule set to a current rule set representing previous wireless communications to form an updated rule set, and to compare the at least a portion of the captured wireless communications to the updated rule set to determine whether the captured wireless communications pose a potential threat.

Other embodiments comprise methods for monitoring network traffic. One or more embodiments of such methods may comprise capturing wireless communications from at least one wireless device. At least one new cluster may be formed or at least one existing cluster may be updated from at least a portion of the captured wireless communications in which the new or existing cluster comprises at least portions of the wireless communications having at least one relevant parameter. At least one rule set may be generated from the at least one new cluster or a rule set relating to the existing cluster may be refined. An updated rule set may be created comprising a combination of a current rule set representing previous wireless communications with either the at least one rule set generated from the new cluster, the refined rule set relating to the existing cluster, or both.

### BRIEF DESCRIPTION OF THE DRAWINGS

FIG. 1 is a block diagram illustrating one or more monitored area(s) with an associated wireless device monitoring system according to embodiments of the invention.

FIG. 2 illustrates a block diagram of a configuration for a monitoring system, according to some embodiments.

FIG. 3 illustrates a block diagram of a configuration for an analysis sensor device and visualization and control system of the monitoring system, according to some embodiments.

FIG. 4 is a flow diagram illustrating network traffic monitoring operation and components according to some embodiments.

FIG. 5 is a flow diagram illustrating a method of monitoring network traffic for potentially threatening wireless communications according to at least one embodiment.

### DETAILED DESCRIPTION

In the following detailed description, circuits and functions may be shown in block diagram form in order not to obscure the present invention in unnecessary detail. Additionally, block definitions and partitioning of logic between various blocks as depicted is non-limiting, and comprise examples of only specific embodiments. It will be readily apparent to one of ordinary skill in the art that the present invention may be practiced in a variety of embodiments implementing numerous other partitioning solutions.

Also, it is noted that the embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process is terminated when its acts are completed. A process may correspond to a method, a function, a procedure, a subroutine, a subprogram, etc. Furthermore, the methods disclosed herein may be implemented in hardware, software, or both.

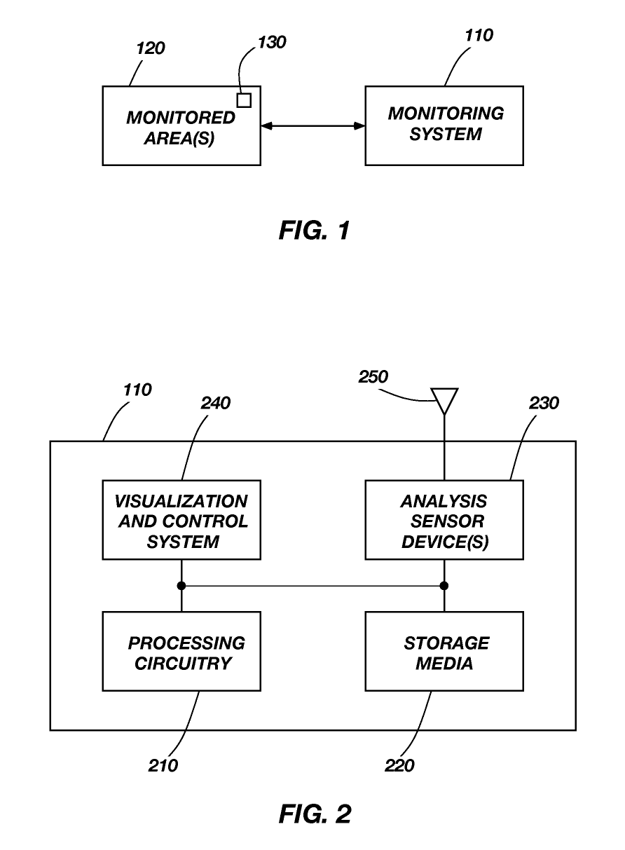

Various embodiments of the present invention are directed toward embodiments of a wireless communication monitoring system for detecting and analyzing communications of wireless devices in a specified area or location and for providing a warning or some other indication when anomalous communication patterns are detected. FIG. 1 illustrates at least one embodiment of a wireless communication monitoring system 110 associated with one or more monitored area(s) 120 (e.g., monitored area(s) 120A, 120B) to monitor wireless communications of one or more wireless devices 130 in the monitored area(s) 120. A monitored area 120 may comprise any area wherein one or more wireless devices 130 may communicate with one another or on a wireless network. By way of example and not limitation, monitored areas 120 may include office buildings, hospitals, prisons, military facilities, schools, universities, hotels, airports, process control facilities, offices or manufacturing floors (e.g., of a corporation, government entity or other organization) in which wireless network communications are enabled. By way of further example and not limitation, wireless devices 130 may include personal electronic devices (PEDs) such as cell phones, pagers, personal music players having wireless communication capabilities (e.g., an iPOD®), smart phones (e.g., a BLACKBERRY®, an iPHONE®), computers (e.g., laptop, handheld, micro, or other), wireless headsets, keyboards, printers, fax machines, personal digital assistants, or any other device comprising or configured with wireless communication capabilities.

In some embodiments, a single analysis sensor device, also referred to herein as an analysis sensor node, of the monitoring system 110 may be positioned to provide wireless communication monitoring functions in the one or more monitored areas 120. In other embodiments, a plurality of analysis sensor devices may be configured to monitor various portions of the one or more monitored area(s) 120. In such an embodiment, the plurality of analysis sensor devices may be configured to communicate with a single visualization and control device. Furthermore, the monitoring system 110 may be implemented differently in other embodiments apart from the examples described herein.

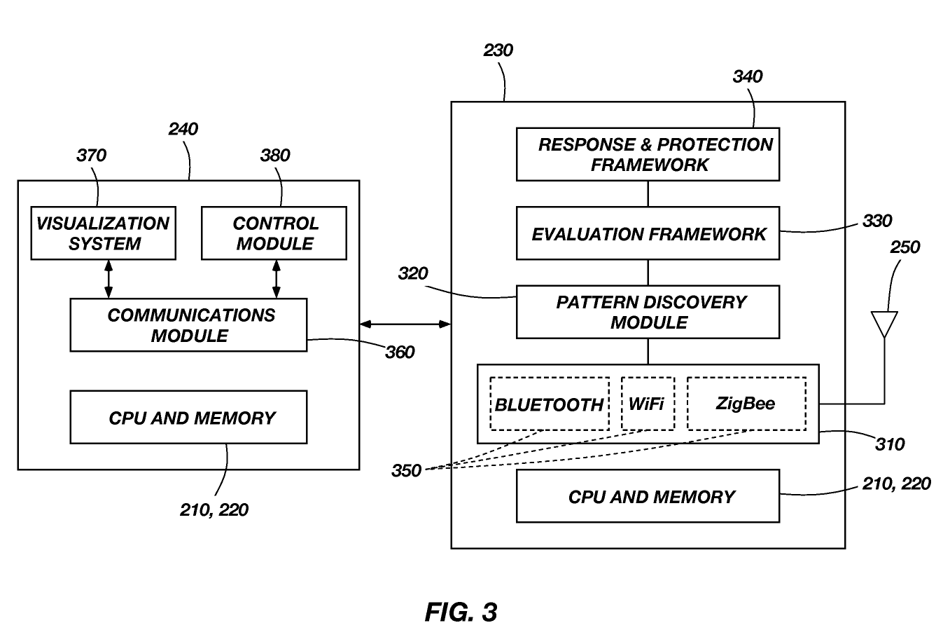

FIG. 2 illustrates a configuration for a monitoring system 110 according to at least some embodiments of the invention. A monitoring system 110 may include processing circuitry 210, storage media 220, at least one analysis sensor device 230, which may also be referred to herein as a sensor node 230, and a visualization and control system 240. Other arrangements within the scope of the invention are contemplated, including more, fewer and/or alternative components. By way of example and not limitation, the embodiments illustrated in FIG. 2 show processing circuitry 210 and storage media 220 being shared between the visualization and control system 240 and the analysis sensor device 230. In other embodiments, however, the visualization and control system 240 and the analysis sensor device 230 may each individually comprise processing circuitry 210 and storage media 220, such as in the embodiments illustrated in FIG. 3.

In some embodiments, processing circuitry 210 is arranged to obtain data, process data, send data, and combinations thereof. The processing circuitry 210 may also control data access and storage, issue commands, and control other desired operations. Processing circuitry 210 may comprise circuitry configured to implement desired programming provided by appropriate media in at least one embodiment. For example, the processing circuitry 210 may be implemented as one or more of a processor, a controller, a plurality of processors and/or other structure configured to execute executable instructions including, for example, software and/or firmware instructions, and/or hardware circuitry. Embodiments of processing circuitry 210 may include a general purpose processor(s), a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor but, in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration. These examples of processing circuitry 210 are for illustration and other suitable configurations within the scope of the invention are also contemplated.

The storage media 220 is configured to store programming such as executable code or instructions (e.g., software, firmware, or a combination thereof), electronic data, databases, or other digital information and may include processor-usable media. A non-limiting example of a database may include information regarding a plurality of network traffic profiles relating to network communications in one or more monitored areas 10. A storage medium may be any available media that can be accessed by a general purpose or special purpose computer. By way of example and not limitation, a storage medium may comprise one or more devices for storing data, including read-only memory (ROM), random access memory (RAM), magnetic disk storage mediums, optical storage mediums, flash memory devices, solid state hard disk, other computer-readable mediums for storing information, and combinations thereof.

Processor-usable media may be embodied in any computer program product(s) or article(s) of manufacture which can contain, store, or maintain programming, data and/or digital information for use by or in connection with an instruction execution system including processing circuitry in the exemplary embodiment. For example, suitable processor-usable media may include any one of physical media such as electronic, magnetic, optical, electromagnetic, infrared or semiconductor media. Some more specific examples of processor-usable media include, but are not limited to, a portable magnetic computer diskette, such as a floppy diskette, zip disk, hard drive, random access memory, read only memory, flash memory, cache memory, and/or other configurations capable of storing programming, data, or other digital information.

At least some embodiments described herein may be implemented using programming stored within appropriate storage media described above and/or communicated via a network or other transmission media and configured to control appropriate processing circuitry. For example, programming may be provided via appropriate media including, for example, embodied within articles of manufacture, embodied within a data signal (e.g., modulated carrier wave, data packets, digital representations, etc.) communicated via an appropriate transmission medium, such as a communication network (e.g., the Internet, a private network, and combinations thereof), wired electrical connection, optical connection and/or electromagnetic energy, for example, via a communications interface, or provided using other appropriate communication structure or medium. Programming including processor-usable code may be communicated as a data signal embodied in a carrier wave, in but one example.

The analysis sensor device 230 is configured to detect and analyze wireless communications generated by one or more wireless devices 130 within the monitored area 120. In some embodiments, the analysis sensor device 230 may be coupled with at least one antenna 250 and may be configured to capture the wireless communications generated by any wireless devices 130 within the monitored area 120, as well as communicate information bi-directionally with other systems or devices of the monitoring system 110. FIG. 3 illustrates a configuration for an analysis sensor device 230 and a visualization and control system 240 according to some embodiments. The analysis sensor device 230 may comprise a sensor node communications module 310, a pattern discovery module 320, an evaluation framework 330 and a response and protection framework 340. Other arrangements for an analysis sensor device 230 are also contemplated, including more, fewer and/or alternative components.

The sensor node communications module 310 is configured to implement wireless and/or wired communications of the analysis sensor device 230. For example, the sensor node communications module 310 is configured to capture wireless communications of wireless devices 130 and to send and/or receive communications to/from a visualization and control system 240 of the monitoring system 110. The sensor node communications module 310 may be coupled with at least one antenna 250 and may include wireless transceiver circuitry for capturing wireless communications from wireless devices 130 as well as for wireless communications with the visualization and control system 240, according to some embodiments. The sensor node communications module 310 may also include a network interface card (NIC), serial or parallel connection, USB port, Firewire interface, flash memory interface, or any other suitable arrangement for communicating with respect to public (e.g., Internet) and/or private networks or other wired arrangements for communicating with the visualization and control system 240, according some embodiments.

The sensor node communications module 310 may include one or more RF detection modules 350 configured for detecting and capturing RF signals of various wireless technologies from wireless devices 130 within the monitored area 120. The RF detection modules 350 comprise wireless transceiver or receiver circuitry configured to support at least one RF communication technology and to capture wireless communications at the raw packet level for the specific technology. By way of example and not limitation, the sensor node communications module 310 may include RF detection modules 350 configured for capturing wireless communications at the raw packet level for technologies such as Bluetooth wireless technology, Wi-Fi (IEEE 802.11), Zigbee, IEEE 802.15.4, ISA 100.11a Standard for Wireless Industrial Networks, WirelessHART, Ultra-Wideband (UWB), Certified Wireless USB, WiMAX, WiBro, as well as any other desired wireless technology. The RF detection modules 350 may, in some embodiments, comprise off-the-shelf sniffer modules configured for sniffing RF communications for one or more technologies. In some embodiments, the sensor node communications module 310 is configured such that various RF detection modules 350 may be added or removed as desired and in accordance with the specific implementation of the monitoring system 110.

As described with reference to FIG. 2 above, the analysis sensor device 230 may be coupled to processing circuitry 210 and storage media 220, or in other embodiments, such as those depicted in FIG. 3, the analysis sensor device 230 may include processing circuitry 210 and storage media 220 integrated therein and configured as conventional CPU and memory. In the embodiments depicted in FIG. 3, the processing circuitry is configured to analyze information contained in the received wireless communications. A pattern discovery module 320 may comprise programming configured to identify at least one specific parameter in the received wireless communications, to form a new cluster or to refine an existing cluster of the wireless communications according to the specific parameters identified, and to generate or create rule sets, also referred to herein as fuzzy rules, relating to the newly formed clusters, or to refine or update an existing rule set relating to the existing cluster. In some embodiments, the pattern discovery module 320 may comprise software, firmware, hardware, and combinations thereof to perform a pattern discovery function in the analysis sensor device 230.

The evaluation framework 330 may comprise programming configured to receive information about the wireless communications and to compare the information of new wireless communication to information relating to previous wireless communications. By way of example and not limitation, the evaluation framework 330 may be configured to evaluate the relationship of captured wireless communications to related rule sets. The evaluation framework 330 may assign a threat level to the new wireless communications based on this evaluation. The evaluation framework 330 may, in some embodiments, be configured to provide detailed information regarding the new wireless communications to the visualization and control system 240 as well as to generate some alarm if the threat level reaches or exceeds some predefined threat index level. The evaluation framework 330 may comprise software, firmware, hardware, and combinations thereof to perform a rule set evaluation function in the analysis sensor device 230.

The response and protection framework 340 may also comprise programming configured to identify a wireless device 130 which may be misbehaving based on the assigned threat level. A misbehaving device may comprise a wireless device 130 which may be attempting to access or modify information, inhibit or end operability of another device or system, obtain partial or complete control of a system or device, or combinations thereof, and the misbehaving device is attempting to do so with malicious intent, without authorization or both. By way of example and not limitation, a misbehaving wireless device 130 may comprise a device carrying out one or more of reconnaissance (e.g., ad hoc stations, rogue access points, open/misconfigured access points), sniffing (e.g., dictionary attacks, leaky access points, WEP/WPA/LEAP cracking), masquerading (MAC spoofing, evil twin attacks/Wi-Phishing attacks), insertion (man-in-the-middle attack, multicast/broadcast injection) and denial-of-service attacks (disassociation, duration field spoofing, RF jamming), as well as any other malicious or unauthorized network communications.

The response and protection framework 340 may also be configured to assign a reputation rating to the misbehaving wireless device 130 which is made available to each analysis sensor device 230 and visualization and control system 240 of the monitoring system 110. The response and protection framework 340 may be configured to identify information regarding a misbehaving wireless device 130. By way of example and not limitation, the response and protection framework 340 may identify the location and the type of misbehaving wireless device 130, and may isolate the misbehaving wireless device 130 and deny connections to other devices or the network. The response and protection framework 340 may comprise software, firmware, hardware, and combinations thereof to perform a response and protection function in the analysis sensor device 230.

The visualization and control system 240 may be configured to receive data relating to detected wireless communications and, in at least some embodiments, to provide an analyst with high-level overviews of intrusion-detection alerts, detailed insight into packet-level network traffic, and direct control over each analysis sensor device 240 in the monitoring system 110. FIG. 3 illustrates a configuration for a visualization and control system 240, according to at least some embodiments. In at least some embodiments, the visualization and control system 240 may comprise a visualization and control system (VCS) communications module 360, a visualization system 370, and a control module 380. As described with reference to FIG. 2 above, the visualization and control system 240 may be coupled to processing circuitry 210 and storage media 220, or in other embodiments, such as those depicted in FIG. 3, the visualization and control system 240 may include processing circuitry 210 and storage media 220 integrated therein and configured as conventional CPU and memory.

The VCS communications module 360 is configured to implement wireless and/or wired communications of the visualization and control system 240. For example, in some embodiments, the communications module 360 may be configured to communicate information bi-directionally with respect to the analysis sensor device 230. The VCS communications module 360 may include wireless transceiver circuitry for receiving wireless communications from one or more analysis sensor devices 230, in some embodiments. The VCS communications module 360 may also include as a network interface card (NIC), serial or parallel connection, USB port, Firewire interface, flash memory interface, or any other suitable arrangement for communicating with respect to public (e.g., Internet) and/or private networks or other wired arrangements for communicating with the one or more analysis sensor devices 230, according some embodiments.

The visualization system 370 is configured to generate the visual displays of intrusion-detection alert overviews as well as details and insight into packet-level network traffic. The visualization system 370 may include programming configured to receive data generated by the analysis sensor device 230 and to generate visual representations of the received data, including charts, graphs, or other visual representations. The visualization system 370 may include a display (not shown) for displaying the visual representations and visual depictions of the received data. This may include visualizations and depictions showing what wireless devices 130 are within the monitored area(s) 120 and the communications activities engaged in by those wireless devices 130.

The control module 380 may be configured to control at least some of the operations of the analysis sensor devices 230. For example, the control module 380 may be configured to provide some communication to the analysis sensor devices 230 indicating what parameters the analysis sensor devices 230 should monitor, how often to provide data regarding detected wireless communications, as well as how to respond to a wireless device having a high threat level. The control module 380 may be automated based on predetermined criteria or it may be configured to carry out manually selected operations by an administrator, or both.

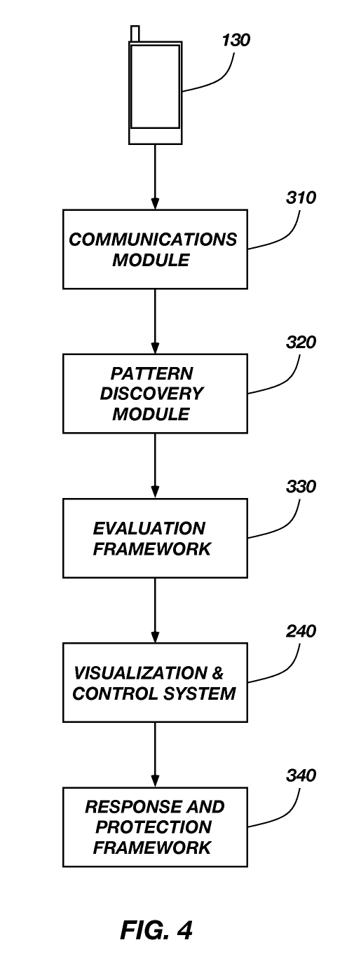

Referring to FIG. 4, monitoring wireless communications with a monitoring system 110 is shown and described according to at least one embodiment. Initially, an analysis sensor device 230 comprises a sensor node communications module 310 configured to monitor for the presence of wireless communications from a wireless device 130. As described above, the sensor node communications module 310 comprises a RF detection module 350 configured to detect wireless communications for at least one type of technology (e.g., Bluetooth, WiFi, Zigbee, etc.). In some embodiments, the RF detection modules 350 comprise sniffers configured to capture all wireless network traffic detected by the sensor node communications module 310 for a specific technology. Each RF detection module 350 may comprise a sniffer configured for one or more specific technologies. In some embodiments, the sniffers may also be configured to perform some initial analysis of the captured data. By way of example and not limitation, sniffers may be configured to detect the location within a data packet of one or more specific parameters and then identify those locations, the specific parameters, or both to the pattern discovery module 320 for further analysis. In other embodiments, the sniffers may merely provide the data packets as received to the pattern discovery module 320 for any analysis. By way of example and not limitation, an example of some suitable off-the-shelf sniffers may include the FTS4BT sniffer for Bluetooth communications and the MeshDecoder sniffer for ZigBee communications, both by Frontline Test Equipment, Inc. of Charlottesville, Va.

Communications patterns and data packets reveal information about the nature of wireless communications; e.g., the frequency and time between keystrokes/mouse clicks, duration and size of voice communication packets, the profiles/protocols employed, etc. This data specifies information about the device and its user that can be employed in various ways by the entity monitoring the communications. Thus, the pattern discovery module 320 may comprise programming configured to identify one or more specific parameters in the received data packets, to form at least one new cluster or refine and existing cluster of the data packets according to the specific parameters identified, and to generate rule sets from the specific parameters and/or other parameters in the data packets relating to the formed clusters.

The pattern discovery module 320 is configured to receive the data packets representing the wireless communications and to identify at least one specific parameter contained within the data packets. The data packets containing the specific parameters are mined by the pattern discovery module 320. Data mining in the pattern discovery module 320 creates some knowledge of the wireless communications traffic (e.g., knowledge regarding natural groupings of data elements), and provides complex multidimensional data traffic patterns embellished in groupings of similar patterns.

Data mining may comprise recognizing relationships and patterns in the wireless communications and extracting the wireless communications comprising those relationships and patterns. By way of example and not limitation, the pattern discovery module 320 may be configured to analyze the data packets to identify one or more parameters, such as the source wireless device, the destination wireless device, the targeted port number, the packet size, the profile, the protocol, the frame number, the channel number, and/or other parameters depending on the communication technology. The pattern discovery module 320 may then extract the received data packets containing the one or more relevant parameters to be further analyzed by the pattern discovery module 320. In other words, as data packets are communicated from the sensor node communications module 310 to the pattern discovery module 320, the pattern discovery module 320 is configured to identify and extract those data packets having one or more relevant parameters, the parameters being predetermined by the analyst.

The mined data is then grouped together to form a cluster according to some similarity of the relevant parameters. For example, wireless communications having a similar destination wireless device 130, protocol, etc. may be grouped together to form a cluster. The cluster, therefore, comprises data packets from wireless communications having one or more relevant parameters that are determined to be substantially similar. In at least one embodiment, the pattern discovery module 320 may form clusters from the mined data according to the process described in the publication Intelligent Control in Automation Based on Wireless Traffic Analysis, Kurt Derr & Milos Manic, IEEE Conference on Emerging Technologies & Factory Automation (ETFA), 249-56 (Sep. 25-28, 2007), the entire disclosure of which is incorporated herein by this reference. In particular, section 3.1 of the publication describes the first phase of what is described as the “Traffic Pattern Intelligent Control Algorithm,” a simple knowledge extraction algorithm. The knowledge extraction algorithm described therein comprises a single layer neural network which is based on the weight update formula

$${W}_{k} = \frac{IPF \cdot {W}_{k} + α X}{m + 1} ,$$

where IPF is an importance factor, determined by the number of patterns already belonging to a cluster k, and alpha is a weight constant defining the importance of input pattern X. The weight set for a cluster k is therefore based on a previous weight vector, number of belonging patterns, and a newly added pattern to that cluster. The attracting radius is based on a Euclidian Distance (ED):

$$ED = \sqrt[2]{{\sum }_{i = 1}^{m} {( {x}_{i} - {w}_{i} )}^{2}} ,$$

between input pattern x and an m-dimensional cluster identifying neuron with weights wᵢ. As a result, a set of clusters is identified by the equation C={Cᵢ|i=1, 2, . . . ,n}, where n is the number of clusters recognized. A center of gravity and radius is associated with each cluster. The algorithm generally detects convex shape spaces only, where the radius intensity is driven by the furthest pattern belonging to a cluster. Such an algorithm produces clusters based on data only and not based on initial parameters. Unlike conventional clustering processes, this process will produce the same result each time for every run of the process assuming alpha (a) values associated with each pattern are kept the same.

With data packets from the wireless communications grouped together into clusters, the pattern discovery module 320 generates rules from the cluster. The pattern discovery module 320 is configured to apply fuzzy logic to generate the rules by fuzzy mapping of the clusters. In at least one embodiment, the fuzzy mapping may be carried out in the pattern discovery module 320 by performing the fuzzy controller design described in section 3.2 of the publication “Intelligent Control in Automation Based on Wireless Traffic Analysis” referred to above. That publication describes a fuzzy logic controller design which is based on two factors: the shape of detected clusters and the weighting of inner cluster space. The shape of the detected clusters is determined by fuzzy mapping the clusters. Fuzzy mapping comprises mapping each dimension (e.g., each additional parameter of the data packets) of each cluster to one-dimension fuzzy class descriptors. A fuzzy class descriptor comprises an ensemble of fuzzy sets describing a certain profile for one dimension. By way of example and illustration and not by way of limitation, a fuzzy class descriptor may comprise a classification such as packet size, and the fuzzy sets comprising the fuzzy class descriptor may comprise fuzzy sets for small, medium and large packet sizes. For example, for a single cluster in 3-dimensional space (i.e., having three identified additional parameters), three fuzzy class descriptors would exist, one fuzzy class descriptor for each of the x, y, and z dimensions. Each fuzzy class descriptor is further decomposed into a plurality of fuzzy sets (FS), one fuzzy set for each identified cluster. Each cluster is weighted by applying a method similar to a Zadeh or Takagi-Sugeno controller.

The pattern discovery module 320 is configured to repetitively perform the mining, clustering and fuzzy mapping to newly observed data and to combine the new rule sets to the current rule sets (rule sets generated from previous wireless communications as they exist prior to the newly observed data) and to refine existing rule sets to form an updated rule set, which may also be referred to herein as existing knowledge. In other words, the updated rule set comprises the current rule sets as updated by refining one or more existing rules sets or by combining one or more new rule sets therewith or both. This continuous refining of the current rule sets updates and expands the existing knowledge of anomalous and normal network behavior for use by the monitoring system 110.

The evaluation framework 330 is configured to evaluate newly captured wireless communications to compare the newly captured wireless communications with the updated rule set to determine a difference from the previous wireless communications. The evaluation framework 330 assigns a threat level to the newly captured wireless communications based on the similarity or difference of the newly captured wireless communications with the updated rule set. If the assigned threat level is greater than some predetermined threshold (i.e., the network traffic has reached some predefined threat index level), the evaluation framework 330 is configured to generate an alert. Furthermore, the evaluation framework 330 may be configured to provide details about the newly created fuzzy rules or the specifics about the related network traffic or both to the visualization and control system 240. In at least some embodiments, the evaluation framework 330 may provide the details about the related network traffic to the visualization and control system 240 in the same or a similar manner as conventional sniffers provide network traffic details to similar visualization systems.

The visualization and control system 240 is configured to visually display the details about the related network traffic for a network administrator. Furthermore, upon analysis of network traffic defined by the analysis sensor device 230 as comprising potentially threatening wireless communications, a network administrator may be able to further define the wireless communications as safe or threatening. If the network administrator classifies the wireless communications as safe, the visualization and control system 240 may communicate the classification to the evaluation framework 330, which may then associate this classification with the fuzzy rules relating to the suspect network traffic to update and expand the existing knowledge of the monitoring system 110. Thus, future network traffic that is similar to the network traffic associated with the newly created fuzzy rules may no longer generate a threat level greater than the predetermined threshold. In this manner, the existing fuzzy rules are constantly updating and evolving over time to adapt to normal changes in network traffic behavior.

The visualization and control system 240 may also be configured to communicate with the analysis sensor device 230 and direct the response and protection framework 340 to identify a wireless device 130. If the wireless communications of a wireless device 130 are determined to be at least potentially threatening, the response and protection framework 340 may assign a reputation rating which may be employed by the monitoring system 110 in determining the potential threat of future communications by that wireless device 130. In some embodiments, the response and protection framework 340 may be configured to isolate the threatening or misbehaving wireless device 130 so that the analysis sensor device 230 may deny connections to that wireless device 130 with other devices or with the network. Furthermore, in some embodiments, the response and protection framework 340 may be configured to determine the physical location of a wireless device 130. The physical location of a wireless device 130 may be determined by employing a conventional location detection method as are known to those of ordinary skill in the art. For example, U.S. Pat. No. 6,950,661, the disclosure of which is incorporated herein in its entirety by this reference, discloses a location detection method, apparatus and program for detecting the location of a wireless device, such as a cellular device.

In operation, according to one embodiment, an individual analysis sensor device 230 may monitor for, and capture one or more wireless communications at one or more monitored areas 120. By way of example and not limitation, the sensor node communications module 310 may detect a wireless communication such as a Bluetooth wireless communication. The wireless communication comprises data packets containing information specific to that wireless communication technology. For example, for Bluetooth communications, each Bluetooth packet may comprise data and control information from a plurality of layers in the protocol stack. By way of example and not limitation, layers in the protocol stack may include baseband, link management (LMP), L2CAP, RFCOMM, SDP, OBEX, and OPP. Each layer comprises a plurality of parameters that may be detected and analyzed in the analysis sensor device 230. By way of example and not limitation, parameters in the baseband layer that may be identified and used in analyzing data packets may include role (slave/master), channel number, clock, flow, type, am_addr, L2CAP_flow, logical link ID, sequence number, arqn, and payload length. Parameters from the link management layer that may be identified and used in analyzing data packets may include role (slave/master), address, op_code, and transaction ID. Parameters for the L2CAP layer that may be identified and used in analyzing data packets may include role (slave/master), address, protocol data unit (PDU) length, channel ID, code, identified, command length, protocol, and source channel ID. Other parameters in any of these or other layers may also be identified and used according to various implementations, such as packet size, profile/protocol type, check sum, sub-protocol, destination devices, targeted port number, etc.

In at least one implementation, for example, Bluetooth wireless communications may be captured for a series of files transferred between Bluetooth master and slave devices employing the File Transfer Profile/Protocol (FTP). The pattern discovery module 320 may mine information and either form at least one cluster of the data packets according to one or more parameters or refine an existing cluster with the data packets according to the one or more parameters. For example, the frame numbers and channel numbers may be mined from a series of data packets and the data packets may be grouped according to these two parameters to form either a new cluster or to be added to an existing cluster. Thus, one or more clusters may be formed or refined having data packets with related frame numbers and channel numbers.

With the data grouped together in clusters, the pattern discovery module 320 generates a fuzzy class descriptor comprising a plurality of fuzzy sets. By way of example and not limitation, the pattern discovery module 320 may map additional specific parameters of the clustered data packets. In the example above, the data packets were clustered according to the frame numbers and channel numbers. Therefore, fuzzy class descriptors may be generated for additional parameters, such as any of those parameters listed above or others which may not have been used in the original clustering. The fuzzy class descriptors may be generated for one or a plurality of additional parameters.

After the new or existing cluster has been mapped to fuzzy space, the fuzzy sets are weighted and boundaries are created for the threat levels. The fuzzy sets are added to the existing knowledge to update the existing knowledge and generate updated fuzzy rules or updated rule set. The captured data packets may be communicated to the evaluation framework 330 for comparisons with the updated fuzzy rules. Continuing with the non-limiting example set forth above, the evaluation framework 330 may receive the data packets selected according to frame numbers and channel numbers and mapped to fuzzy space according to additional parameters, for example packet size. The evaluation framework 330 may then compare the data packets from the new traffic with the updated fuzzy rules determine what difference, if any, there is from the traffic patterns defined by the updated fuzzy rules. In other words, and by way of example only, the evaluation framework 330 looks to the updated fuzzy rules, comprising the current rule sets updated with the new wireless communications, which may indicate that data packets having the specific frame numbers and channel numbers generally have, for example, a packet size of a particular size, or some other parameter. The evaluation framework 330 then evaluates the new data packets to determine by how much, if any, the packet size, or other parameter, of the new data packets that were selected with related frame numbers and channel numbers may differ from the updated fuzzy rules. According to the amount of difference as defined by the distance from the center of gravity of the related cluster, the evaluation framework 330 derives a threat level assigned to the new data packets. The threat level for the new data packets is added to the existing knowledge to improve, update and expand the knowledge used to define traffic patterns.

In implementations in which the new data packets are assigned a threat level above some threshold, the evaluation framework 330 may signal an alarm. The alarm may be audible, visual, or some other signal or combination thereof. The evaluation framework 330 further may provide detailed information to the visualization and control system 240 illustrating details about the parameters of the data packets for an administrator to review. The visualization and control system 240 may comprise a monitor which the administrator may use to view the details about the threatening wireless traffic. The administrator may determine the traffic to be safe, in which case the visualization and control system 240 may communicate such determination to the analysis sensor device 230 to increase the general knowledge of the monitoring system 110. On the other hand, if the administrator determines the traffic is a threat, the visualization and control system may communicate such a determination to the response and protection framework 340 of the analysis sensor device 230. The response and protection framework 340 may determine the location of the threatening wireless device 130, may isolate the communications of the threatening wireless device 130, or other actions to protect the network and other devices.

Although this example has been illustrated with relation to Bluetooth wireless communications, it should be apparent to those of ordinary skill in the art that the same or similar procedures may be adapted for various other wireless communication technologies (Wi-Fi, Zigbee, WiMax, etc.). For example, the example described may work with other wireless communication technologies by generally adjusting the specific information from the data packets or the location of the information in the data packets that is used for mining, clustering, and generating fuzzy rules.

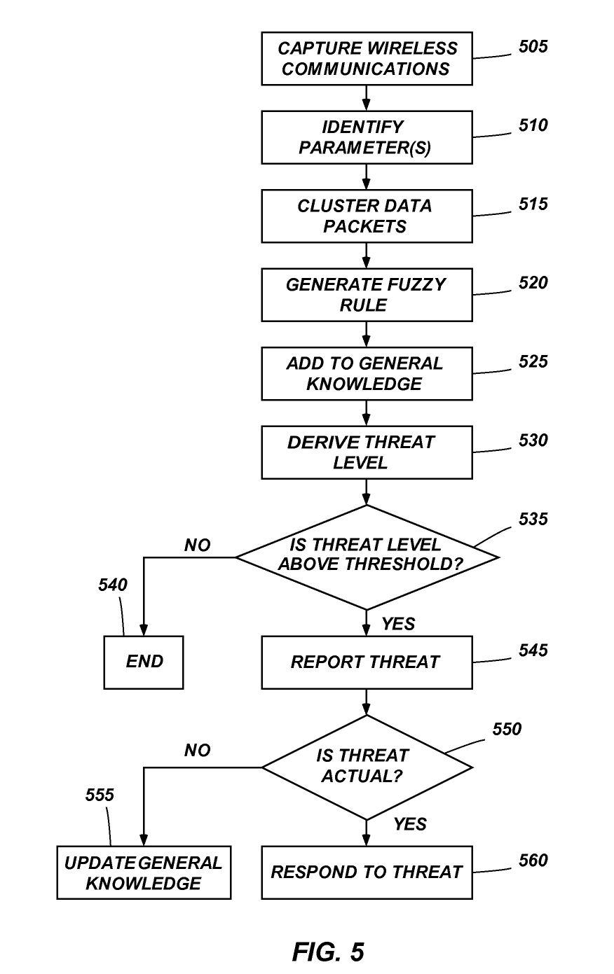

FIG. 5 is a flow diagram illustrating a method of monitoring wireless communications according to some embodiments of the present invention. Other methods are possible including more, less, and alternative acts. Wireless communications between two or more wireless devices 130 are captured 505. The wireless communications may be captured in their raw packet level by methods known to those of ordinary skill in the art. By way of example and not limitation, those methods employed by conventional sniffers may be employed for capturing the wireless communications in some embodiments. Indeed, the wireless communications may be captured by sniffing the wireless communications being carried out between at least two wireless devices, or by a single wireless device scanning for other wireless devices in the monitored area 120.

One or more parameters from the raw data packets may be identified and those packets, or at least portions thereof, may be mined 510. The data packets may further be grouped together according to the one or more identified parameters to form one or more new clusters of data packets having the relevant parameters or to refine one or more existing clusters having the relevant parameters 515. Parameters may include, as a non-limiting example, information contained in one or more headers of one or more layers of the encapsulated data comprising the data packet. Clusters may be mapped to fuzzy space to create one or more fuzzy class descriptors defined by multi-dimensional mapping of a cluster and may include at least one additional parameter. These fuzzy class descriptors define fuzzy rules relating to the clusters mapped to the one or more additional parameters 520. The new fuzzy rules are added to the general knowledge or the existing fuzzy rules are refined to update, expand and adapt the general knowledge to the ever changing wireless communications on a conventional network 525.

The captured data packets may be evaluated by comparing the captured data packets to the updated fuzzy rules to determine the difference between the captured data packets and the updated fuzzy rules. Based on the difference between the captured data packets and the updated fuzzy rules, a threat level may be derived for those captured data packets 530. The assigned threat level is analyzed to determine whether the threat level is within some predetermined threshold, defined as being safe wireless communications, or whether the threat level is above the threshold, defined as being potentially threatening wireless communications 535. If defined as being not above the threshold and as being safe, the process in some embodiments of the method may end 540.

If the threat level is above the threshold, the threatening wireless communications may be reported to a network administrator 545. The reporting may comprise generating an alarm (e.g., audio, visual, etc.) or generating visual representations and data for review by the network administrator, or a combination thereof. The network administrator may determine if the wireless communications pose an actual threat or if the wireless communications are instead just new and different, but safe, network traffic 550. The network administrator may review the threat level assigned to the wireless communications, and detailed information about the wireless communications to determine if the behavior of the wireless communications is actually threatening. If it is determined that the threatening wireless communications are safe, this determination will be added to the general knowledge to update the general knowledge 555.

If the potentially threatening wireless communications are determined by the administrator to comprise a real threat, a response is carried out to protect the network from the threat 560. The response may include locating the wireless device 130 conducting the threatening wireless communications, isolating the communications from the threatening wireless device 130 from communicating with other wireless devices 130, as well as other potential responses or combinations of responses.

While certain embodiments have been described and shown in the accompanying drawings, such embodiments are merely illustrative and not restrictive of the scope of the invention, and this invention is not limited to the specific constructions and arrangements shown and described, since various other additions and modifications to, and deletions from, the described embodiments will be apparent to one of ordinary skill in the art. Thus, the scope of the invention is only limited by the literal language, and legal equivalents, of the claims which follow.

What is claimed is:

1. A monitoring device, comprising:
a communication module configured to capture wireless communications of a wireless device within a monitored area; and
processing circuitry coupled with the communication module and configured to:
form a new cluster comprising at least a portion of the captured wireless communications according to at least one specific parameter identified in the at least a portion of the captured wireless communications;
generate at least one rule set relating to the formed new cluster;
combine the at least one rule set to a current rule set representing previous wireless communications to create an updated rule set;
compare the captured wireless communications to the updated rule set to determine a difference from the previous wireless communications; and
generate an alert if the difference is greater than a predetermined threshold.

2. The monitoring device of claim 1, wherein the communication module comprises at least one RF detection module configured to capture wireless communications for at least one wireless technology.

3. The monitoring device of claim 2, wherein the RF detection module is configured to capture wireless communications for at least one wireless technology selected from the group consisting of Wi-Fi (IEEE 802.11), Zigbee, IEEE 802.15.4, ISA 100.11a Standard for Wireless Industrial Networks, WirelessHART, Ultra-Wideband (UWB), Certified Wireless USB, WiMAX, WiBro.

4. The monitoring device of claim 1, wherein the communication module is further configured to identify the at least one specific parameter in the captured wireless communications and to provide information to the processing circuitry regarding at least a location of the identified at least one specific parameter in the captured wireless communications.

5. The monitoring device of claim 1, wherein the processing circuitry is further configured to update an existing cluster from at least another portion of the captured wireless communications according to at least one other specific parameter, and refine a rule set relating to the existing cluster.

6. The monitoring device of claim 5, wherein the at least one specific parameter and the at least one other specific parameter are selected from the group of parameters consisting of a source wireless device, a destination wireless device, a targeted port number, a packet size, a profile, a protocol, a frame number, a channel number, a check sum, and a sub-protocol.

7. The monitoring device of claim 1, wherein the processing circuitry is further configured to determine a physical location of the wireless device in the monitored area.

8. The monitoring device of claim 1, further comprising a response and protection framework configured to identify a location of the wireless device generating the wireless communications, isolate the wireless device from further communications and assign a reputation rating to the wireless device.

9. A system for monitoring network traffic, comprising:
at least one analysis sensor device comprising:
a communications module configured to capture wireless communications of a wireless device within a monitored area; and
programming configured to: form a new cluster comprising at least a portion of the captured wireless communications which comprise at least one relevant parameter; generate at least one rule set relating to the new cluster; combine the at least one rule set to a current rule set representing previous wireless communications to form an updated rule set; and compare the at least a portion of the captured wireless communications to the updated rule set to determine whether the captured wireless communications pose a potential threat;
at least one storage media accessible by the programming and configured to store at least the current rule; and
a visualization and control system coupled to the at least one analysis sensor device and configured to generate a visual representation of at least a portion of the captured wireless communications.

10. The system of claim 9, wherein the communication module comprises at least one RF detection module configured to capture wireless communications for at least one wireless technology.

11. The system of claim 10, wherein the RF detection module is configured to capture wireless communications for at least one wireless technology selected from the group consisting of Wi-Fi (IEEE 802.11), Zigbee, IEEE 802.15.4, ISA 100.11a Standard for Wireless Industrial Networks, WirelessHART, Ultra-Wideband (UWB), Certified Wireless USB, WiMAX, and WiBro.

12. The system of claim 9, wherein the programming of the at least one analysis sensor device comprises an evaluation framework configured to compare the at least a portion of the captured wireless communications to the updated rule set.

13. The system of claim 9, wherein the visualization and control system comprises:
a visualization system configured as a display; and
a control module configured to communicate with the at least one analysis sensor device and to control at least some operations thereof.

14. The system of claim 9, wherein the programming is further configured to update an existing cluster from at least another portion of the captured wireless communications according to at least one other relevant parameter, and to refine a rule set relating to the existing cluster.

15. A method of monitoring network traffic, comprising:
capturing wireless communications from at least one wireless device;
forming at least one new cluster comprising at least a portion of the captured wireless communications having at least one relevant parameter;
generating at least one rule set from the at least one cluster;
creating an updated rule set comprising a combination of the at least one rule set with a current rule set representing previous wireless communications;
evaluating the difference of the at least one rule set from the updated rule set and deriving a threat level for the captured wireless communications based on the evaluation.

16. The method of claim 15, wherein capturing the wireless communications comprises sniffing the wireless communications between at least two wireless devices.

17. The method of claim 15, wherein capturing the wireless communications comprises capturing the wireless communications in a raw packet level.

18. The method of claim 15, wherein forming the at least one new cluster comprises:
identifying the at least one relevant parameter in the at least a portion of the captured wireless communications; and
grouping together a plurality of data packets comprising the at least a portion of the captured wireless communications in which the at least one relevant parameter is similar.

19. The method of claim 18, wherein forming the at least one cluster from the captured wireless communications comprises:
identifying a plurality of relevant parameters in the at least a portion of the captured wireless communications; and
grouping together a plurality of data packets comprising the at least a portion of the captured wireless communications wherein the plurality of parameters are similar as a whole.

20. The method of claim 15, further comprising:
updating an existing cluster with another portion of the captured wireless communications having at least one other relevant parameter; and
refining a rule set relating to the existing cluster.

21. The method of claim 20, wherein the at least one relevant parameter and the at least one other relevant parameter comprise parameters selected from the group consisting of a source wireless device, a destination wireless device, a targeted port number, a packet size, a profile, a protocol, a frame number, a channel number, a check sum, and a sub-protocol.

22. The method of claim 15, further comprising generating at least one visual depiction of information related to the captured wireless communications and displaying the at least one visual depiction to an administrator.

23. The method of claim 15, further comprising communicating the threat level of the captured wireless communications to an administrator.

24. The method of claim 23, further comprising determining if the threat level of the captured wireless communications is accurate, comprising:
reviewing the threat level communicated to the administrator; and
reviewing additional information relating to the captured wireless communications.

25. The method of claim 15, further comprising identifying a physical location of the at least one wireless device.
